(19) United States
(12) Patent Application Publication
(10) Pub. No.: US 2016/0221115 A1
(43) Pub. Date: Aug. 4, 2016

(54) METHOD FOR MANUFACTURING AN ELEMENT AND ELEMENT

(71) Applicant: ALSTOM Technology Ltd, Baden (CH)

(72) Inventors: Kaspar LOEFFEL, Zurich (CH); Michael Thomas MAURER, Bad Sackingen (DE); Dariusz PALYS, Gebenstorf (CH)

(21) Appl. No.: 15/006,400

(22) Filed: Jan. 26, 2016

(30) Foreign Application Priority Data
Feb. 3, 2015 (EP) 15153538.2

(51) Int. Cl. B23K 15/00; B23K 26/342

(52) U.S. Cl. CPC B23K 15/0086; B23K 26/342; B33Y 10/00

(57) ABSTRACT

A method for manufacturing an element by an additive manufacturing process is disclosed. The method comprises manufacturing the element such as to comprise a front face extending from the base side and into the buildup direction. The method further comprises manufacturing at least one bump structure on said front face by means of the additive manufacturing process, wherein a delimitation of said bump structure comprises at least one reclining ledge and at least one overhang ledge. The overhang ledges are manufactured such as to form an angle with the buildup direction being smaller than or equal to 70 degrees. Further, elements producible by the method are disclosed.

### CROSS-REFERENCE TO RELATED APPLICATIONS

This application claims priority to European Patent Application No. 15153538.2 filed Feb. 3, 2015, the contents of which are hereby incorporated in its entirety.

### TECHNICAL FIELD

The present disclosure relates to a method for manufacturing an element by an additive manufacturing process. It further relates to an element producible by said method.

The additive manufacturing process comprises consecutively adding material to the element along a buildup direction starting from a base side of the element in producing a base side transverse to the buildup direction and adding material starting at the base side in consecutive steps, advancing in the buildup direction from one step to a subsequent step. The additive manufacturing process may in particular be a selective laser melting process or a selective electron beam melting process.

### BACKGROUND

Additive manufacturing processes become increasingly used in industry. These processes, in which material is added to an element in manufacturing the element rather than removing material from a blank allow for instance the generation of cavities or undercuts which might not or only with significant difficulties be manufactured by a cutting process. Also, restrictions applying to casting processes, as for example the need to avoid abrupt changes of cross-sections, do not apply to additive manufacturing processes.

Additive manufacturing processes for manufacturing metallic parts include for instance selective laser melting or selective electron beam melting processes. In these processes, layers of metallic powder are disposed. A laser beam or electron beam is directed onto the bed of metallic powder, locally melting the powder, and the beam is subsequently advanced on the powder surface. Molten metallic substance solidifies, while the metallic powder at a neighboring location is molten. Thus, a layer of solidified metal is generated along the beam trajectory. After a processing cycle in a layer of material is finished, a new layer of metal powder is disposed on top, and a new cycle of melting and subsequently solidifying the metal is carried out. In choosing the layer thickness and the beam power appropriately, each layer of solidified material is bonded to the preceding layer. Thus, a metallic component is build along a buildup direction of the manufacturing process. The thickness of one layer of material is typically in a range from 10 to 100 micrometers. The process advance or buildup direction from one layer to a subsequent layer typically is from bottom to top in a geodetic sense.

However, certain restrictions also apply to these methods. If, for instance, an overhang structure is to be manufactured in one layer, the overhang structure, if no support for the new layer of solidified material is provided, will bend. As a result, a weak product quality may be found, or the manufacturing process might be canceled. While a remedy for this situation might be to manufacture support structures below overhang structures, and subsequently removing the support structures, it is obvious that an additional manufacturing step involving a removal process, in particular a cutting or chip removing process, will be required, requiring an additional process step, thus adding manufacturing time, and cost. Moreover, for certain geometries manufactured, it might not be possible or very difficult to access and remove the support structures.

### SUMMARY

It is an object of the present disclosure to provide a method for manufacturing an element by an additive manufacturing process. It is a further object of the present disclosure to provide a method for manufacturing an element by an additive manufacturing process overcoming drawbacks of the art. It is a particular object of the present disclosure to overcome the drawbacks of the art cited above. It is a further object of the present disclosure to provide a method for manufacturing an element by an additive manufacturing process allowing the manufacturing of overhang structures without the need to provide specific support structures which need subsequently to be removed.

It is a further object of the present disclosure to provide an element producible by the disclosed method, which comprises overhang structures which do not require specific support structures during the buildup of the structures by an additive manufacturing method.

These objects, and other objects, are achieved by the method as recited in claim 1 and by the element as recited in the independent claims claiming elements.

A method for manufacturing an element by an additive manufacturing process is disclosed, wherein the additive manufacturing process comprises consecutively adding material to the element along a buildup direction starting from a base side. The base side is manufactured transverse to the buildup direction and material is added in consecutive steps starting at the base side. The method comprises manufacturing the element such as to comprise a front face extending from the base side and into the buildup direction. Further, at least one bump structure is manufactured on said front face by means of the additive manufacturing process. The bump structure is delimited by a delimitation, wherein a delimitation of said bump structure comprises at least one reclining ledge and at least one overhang ledge. The bump structure may be a concave or a convex bump structure. A bump structure may in certain embodiments be a depression on the front face, that is, a concave bump structure, not penetrating the element, and comprising a back wall. It might likewise be a convex bump structure, that is, an elevation on the face. Convex bump structures as well as concave bump structures might be provided on the front face. The method as disclosed herein comprises manufacturing all overhang ledges of a bump structure, and in particular all overhang structures of all bump structures, to form an angle with the buildup direction being smaller than or equal to 70 degrees. In more specific embodiments, the angle may be smaller than or equal to 60 degrees, may in particular be smaller than or equal to 50 degrees, and may more specifically be at least approximately 50 degrees.

It is understood that, if the buildup direction is from bottom to top in a geodetic sense, in other words, vertical, also an angle of the overhang ledges with a horizontal may be defined. Said angle with the horizontal is larger than or equal to 20 degrees. In more specific embodiments the angle formed with the horizontal is larger than or equal to 30 degrees, may in particular embodiments be larger than or equal to 40 degrees, and may more specifically be at least approximately 40 degrees.

It is further understood that the base side needs not to be manufactured in one layer. If the base side is for instance arched, lateral segments of the base side may be manufactured first and the base side may be finished in subsequent buildup steps. Generally, the base side is the lower side of the element if for instance the buildup direction is vertical from bottom to top.

Due to the inclination of the overhang ledges, the overhang ledges are self-supporting during the manufacturing process. An additional incremental bearing-out generated while adding a new layer of material will be small enough as to support itself against gravity. The incremental bearing-out or cantilevering distance will be the smaller the smaller the angle between the buildup direction, or the vertical direction, respectively, is during the manufacturing process, or, the larger the angle between the overhang ledge and the horizontal is. It has been shown that good results are generally obtained if an angle between the buildup direction and the overhang ledge is smaller than or equal to 60 degrees, and more particularly said angle may be chosen to be smaller than or equal to 50 degrees, and more particularly may in specific embodiments be at least approximately 50 degrees. The smaller the angle is, the more support will be provided for an incrementally generated overhang. Angles up to 70 and including degrees may still be acceptable. Also, good results have been found if the angle between an overhang ledge and the horizontal is larger than or equal to 30 degrees, more particularly is chosen to be larger than or equal to 40 degrees, and in particular embodiments is at least approximately 40 degrees. The larger the angle is the more support is provided for an incrementally generated overhang. Angles down to and including 20 degrees may be acceptable.

A concave bump structure will generally be delimited in the buildup direction by an overhang ledge, while it will be delimited towards the base side by a reclining ledge. A convex bump structure will generally be limited in the buildup direction by a reclining ledge and will be delimited towards the base side by an overhang ledge. More specifically spoken, if the buildup direction is bottom to top, and the base side constitutes a lower side of the element during the manufacturing process, an overhang ledge will be disposed on the upper side of a concave bump structure and on a lower side of a convex bump structure. Likewise, a reclining ledge will be disposed on the lower side of a concave bump structure and on an upper side of a convex bump structure.

The method may comprise manufacturing a multitude of bump structures on the front face, and it may comprise manufacturing concave bump structures as well as convex bump structures on the front face. In particular, the conditions lined out above and in claim 1 for the overhang ledges will apply to all bump structures manufactured on the front face.

In one aspect of the present disclosure the method comprises manufacturing at least one concave bump structure as a non-penetrating structure. That is to say that the concave bump structure which is manufactured by the additive process does not penetrate the element from the front face to an opposite second face, but is a depression as noted above. In a more specific aspect all concave bump structures may be manufactured as non-penetrating bump structures.

Manufacturing non-penetrating bump structures comprises manufacturing a back wall of the concave bump structure. In this respect the bump structures shall be clearly distinguished from dedicated through openings which might be manufactured in different ways, one of which will be lined out below.

In one mode of carrying out the method according to the present disclosure, it comprises manufacturing at least one bump structure such that a delimitation of said bump structure comprises two adjacent overhang ledges, said overhang ledges including an angle and forming an apex, said apex being arranged at a buildup end of a concave bump structure or on a base end of a convex bump structure. That means, that a tip formed at the abutment location of two overhang ledges points towards the base side of the element in the case of convex bump structure and points towards the buildup direction in the case of a concave bump structure. In case the buildup is performed from bottom to top, i.e. along a vertical direction, the apex formed by two overhang ledges is arranged at the top of a concave bump structure or on the bottom of a convex bump structure.

In still another aspect of the present disclosure, the method comprises manufacturing at least one bump structure such that a delimitation of the bump structure comprises an overhang ledge and a lateral ledge, said overhang ledge and said lateral ledge including an angle and forming an apex, said apex being arranged at a buildup end of a concave bump structure or on a base end of a convex bump structure, the included angle in particular being smaller than or equal to 70 degrees and in particular being smaller than or equal to 60 degrees. A lateral ledge in this context is a ledge extending at least essentially along the buildup direction, that is, in certain embodiments, along a vertical direction.

The method may further comprise manufacturing at least one through opening extending from a first front face to a second front face by the additive manufacturing process. The first and second front faces may in particular be arranged on opposed faces of the element. Manufacturing said through opening may comprise manufacturing a support structure in the through opening and may in particular comprise removing the support structure after the additive manufacturing process has finished by a removing manufacturing process. In providing the support structure, it is possible to manufacture a through opening which is delimited on one side by an overhang ledge extending perpendicular or at least essentially perpendicular to the buildup direction. In particular it is possible to manufacture a through opening which is delimited on one side by a horizontal or approximately horizontal overhang ledge. However, removing the support structure requires a good tooling access to the support structure. While this may be easily done for through openings and in particular for through openings exceeding a certain size, such access may in practice be largely restricted for non-penetrating bump structures, in particular if said bump structures have sizes of some millimeters only. Moreover, in certain embodiments of an element only one or a few through openings may be manufactured, while a manifold of bump structures being sized in a millimeter region may need to be manufactured. It will be appreciated, that the additional removing process may be easily applied for a relatively small number of through openings, but may be very expensive to apply to a large number of bump structures.

As repeatedly mentioned before, the buildup direction in a method according to the present disclosure may be vertical, bottom to top. Bottom to top in this respect means bottom to top in a geodetic sense.

In one aspect, manufacturing the bump structures may be restricted to an additive manufacturing process. In other words, manufacturing the bump structures does not involve a removing or cutting process and in particular does not include a chip removing manufacturing process. It does not mean, that manufacturing the bump structures does not involve any subsequent finishing process, like cleaning, blasting, and so forth.

The additive manufacturing process may be one of a selective laser melting process and a selective electron beam melting process.

An element received by a method as lined out above comprises a first side, a second side arranged opposite the first side, and one front face connecting the first and the second sides. At least one, and in particular a multitude of, bump structures is arranged on the front face. One of the first and second sides is a base side which was manufactured first, and additional material was added by an additive manufacturing process starting from the base side to the other one of the first and second sides. The front face comprises at least one, and in particular a multitude of, bump structures. Each bump structure is delimited by a delimitation. Said delimitation, when the element is put down on a horizontal surface with the base side at the bottom, comprises at least one overhang ledge. Said overhang ledge is not horizontal, but tilted against a horizontal direction at a certain angle. In case the element was manufactured with support points of the base side leveled during manufacturing, the overhang ledge is tilted against the horizontal at the same angle as during manufacturing. If the support points were not leveled during manufacturing, then, of course, the overhead ledges will be tilted accordingly at a larger or smaller angle. More specifically, these conditions will be fulfilled for all overhang ledges of bump structures present on the front face. Furthermore, in certain embodiments, the element will also comprise a through opening extending from the front face to a second, opposed face of the element. One or more through openings may be provided. However, in specific embodiments, the number of through openings is significantly smaller than the number of bump structures, for instance by a factor of 10 or more. Also, the cross-sectional dimension of a through opening may be significantly larger than that of a bump structure, for instance by a factor of 10 or more.

In one aspect of the present disclosure, an element producible by a method described above is disclosed. Said element comprises a first side, a second side, and a face extending form the first side to the second side, wherein bump structures are arranged on said face. The bump structures are delimited by delimitations, a delimitation comprising at least one reclining ledge and one overhang ledge when the element is put down on a horizontal surface with one of the first and second sides. Each overhang ledge of a bump structure, and in particular each overhang ledge of each bump structure, is tilted against a horizontal line when the element is put down on a horizontal surface with one of the first and second sides, wherein the tilt angle in particular is larger than or equal to 20 degrees. In more particular embodiments said angle may be larger than or equal to 30 degrees and in more particular embodiments may be larger than or equal to 40 degrees. It is understood that, for the reasons lined out above, said tilt angle may differ from the tilt angle during the manufacturing process. In further embodiments of the element, these conditions may be fulfilled for each overhang ledge of each bump structure.

In still another aspect of the present disclosure, an element producible by a method as described above is disclosed, the element comprising a first side, a second side, and a face extending form the first side to the second side. Bump structures are arranged on said face, a bump structure being delimited by a delimitation, the delimitation comprising at least one reclining ledge and one overhang ledge when the element is put down on a horizontal surface with one of the first and second sides. Each overhang ledge abuts a second ledge, forming an apex with said second ledge, said apex pointing towards one of the first and second sides. In one specific embodiment the first ledge is an overhang ledge. The first and second overhang ledges include an angle, said angle being smaller than or equal to 120 degrees and larger than or equal to 95 degrees, and said angle is in particular smaller than or equal to 105 degrees. In a further specific embodiment of the element, an overhang ledge abuts a second ledge and includes an angle with the second ledge being smaller than or equal to 80 degrees and in particular being smaller than or equal to 60 degrees. The second ledge, in this embodiment, may or may not be an overhang ledge.

In still a further aspect of the present disclosure, an element is disclosed with at least one diamond-shaped bump structure being arranged on a front face. The diamond-shaped bump structure includes an angle between two delimiting ledges which is smaller than or equal to 105 degrees and is larger than or equal to 95 degrees. In particular, said angle equals at least approximately 100 degrees. In a more specific embodiment, the two ledges forming said angle are both overhang ledges.

It is understood that the features of various embodiments described above may be combined with each other.

### BRIEF DESCRIPTION OF THE DRAWINGS

The present invention is now to be explained more closely by means of different embodiments and with reference to the attached drawings. The figures of the drawing show

FIG. 1 general production of an overhang be a powder melting process;

FIG. 2 a method according to the present disclosure;

FIG. 3 a combustor front panel manufactured by a method according to the present disclosure after finalizing the additive manufacturing process;

FIG. 4 the combustor front panel of FIG. 3 after final processing;

FIG. 5 a concave bump structure;

FIG. 6 a convex bump structure;

FIGS. 7-9 exemplary embodiments of concave bump structures in a plan view.

The embodiments shown in the figures are schematic. They are intended to facilitate understanding of the disclosure of the present document and are not intended to limit the scope of the claims attached hereto.

### DETAILED DESCRIPTION

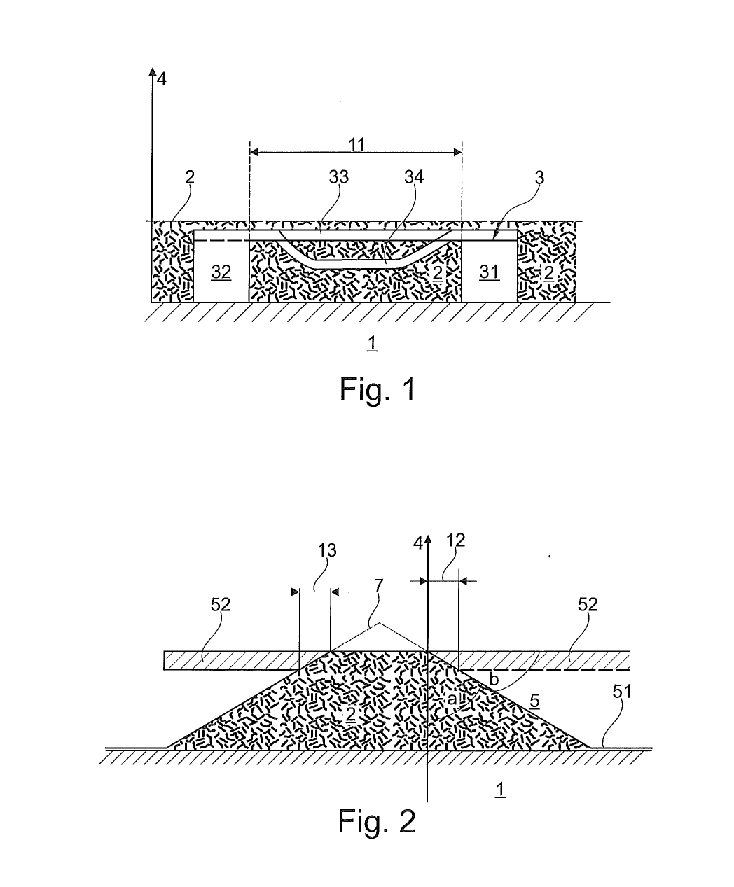

A problem underlying the invention is depicted in FIG. 1. In a selective laser melting process a metal powder 2 is disposed on a build platform 1. It is noted, that the bed of metal powder 2 shown in FIG. 1 is not disposed in one step, but disposed in consecutive layers. Between each disposal step the actual laser melting process takes place. A laser beam of appropriate power is directed onto the metal powder, and advanced on the surface of the metal powder, such that the metal powder is locally molten and subsequently re-solidified. By repeating the steps of disposing metal powder, melting, and re-solidifying, an element 3 is be built. The process of disposing one layer above another advances along the buildup direction 4 which may generally be bottom to top, or vertical. In the state depicted in FIG. 1 two fragments 31 and 32 of element 3 have been built. In an additional processing step a layer 33 bridging the two fragments is produced. Layer 33 bridges a distance 11 between the fragments 31 and 32 as a bridging layer. Initially, the bridging layer 33 is formed by only one layer of solidified metal. Typically, the thickness of this layer is from about 10 to about 100 micrometers. Thus, there is an imminent danger that the initially built bridging layer 33 will bend in response to its own weight and/or the weight of the subsequent layer of metal powder disposed thereon, as indicated at 34.

Thus, it is proposed to apply a method as schematically depicted in FIG. 2. Starting at the build platform 1, metal powder 2 is disposed on the build platform layer by layer. For each layer, the melting and re-solidifying step is carried out along a buildup direction 4. A component or element 5 is thus manufactured starting from a base side 51. In order to manufacture an overhang structure, the overhang structure is manufactured such that it is tilted against the buildup direction 4 at an angle a. As previously mentioned, the buildup direction may typically be from bottom to top, thus, the overhang structure is tilted against a horizontal line, or, a top surface of the component 5, at an angle b. As is seen, in manufacturing an additional layer 52 on top of component 5 the resulting cantilevering distance depicted at 12 and 13 gets comparatively small. The cantilevering distance depends on the thickness of the top layer 52 and the angles a or b, respectively. The smaller angle a is chosen, or the bigger the angle b is chosen, the smaller the cantilevering distance of the top layer 52 gets. If said angles are chosen appropriately, the cantilevering distance 12 and 13 is small enough to bear its own weight and the weight of powder disposed on top of it in a subsequent recoating step. With a typical thickness of top layer 52 in a range from 10 to 100 micrometers, and angle a not exceeding 70 degrees, and in particular not exceeding 60 degrees, the cantilevering distance will in any case be less than 0.3 millimeters. As a result, a roof-type overhang structure as indicated by the dashed lines at 7 will be manufactured.

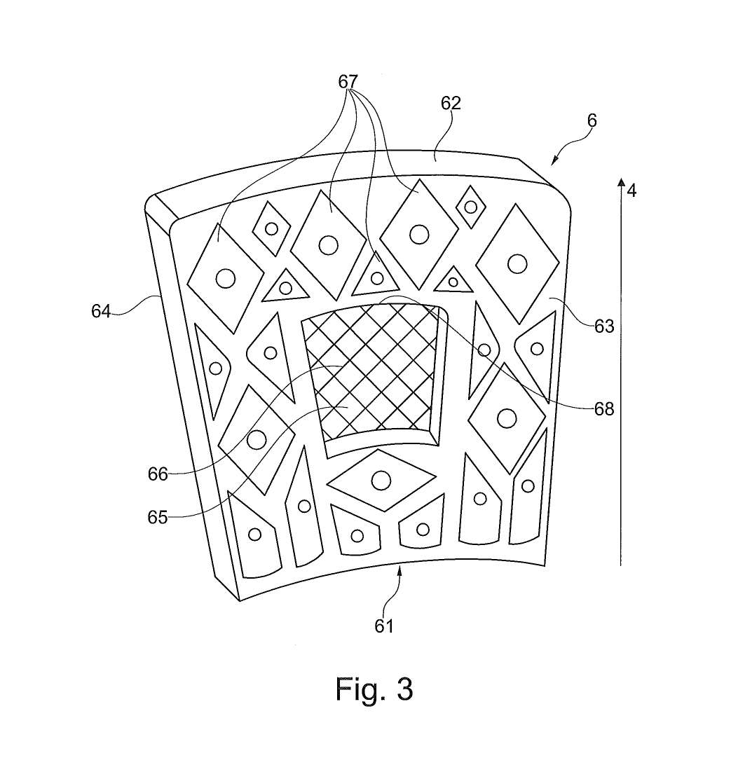

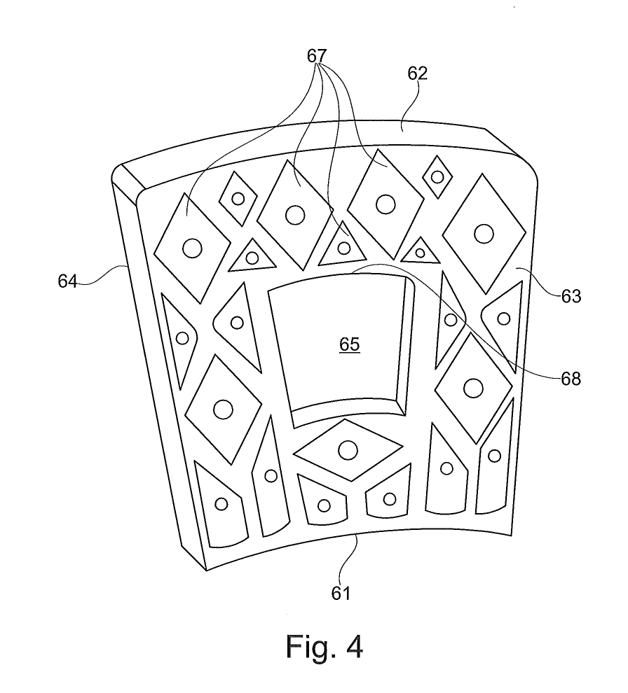

FIGS. 3 and 4 depict the application of a method as proposed herein to the manufacturing of a combustor front panel 6. The combustor front panel 6 comprises a first, base side 61, a second side 62, and a front face 63. A second face denoted at 64 is not visible in this view of the combustor front panel. A through opening 65 is provided in the combustor front panel in order to allow the throughflow of hot gas when the front panel is applied in a combustor. In FIG. 3, struts 66 serving as support structures are shown which have been manufactured by the additive manufacturing process within through opening 65. These support structures 66 serve to support an overhang top boundary 68 of through opening 65 while the manufacturing process is carried out. A buildup direction of the manufacturing process is indicated at 4. As shown in FIG. 4, after the additive manufacturing process has been finished, the struts 66 can be removed by a cutting process. This is relatively easy to perform, due to the size of the through opening, and the accessibility of the struts located within the through opening. Furthermore, the front face 63 is furnished with a multitude of bump structures 67. These bump structures typically are depressions on the front face 63 serving as acoustic dampers. As these depressions are significantly smaller than through opening 65, and moreover delimited by back walls, i.e., the concave bump structures 67 are non-penetrating, access to any support structures which would have been manufactured within the concave bump structures would be much more difficult. Moreover, due to the larger number of concave bump structures, removing any support structures which would have been manufactured to support overhangs would be much more expensive. It is thus found desirable to manufacture the concave bump structures 67 without the need to manufacture support structures, and thus without subsequent cutting, i.e. it is found desirable to restrict the manufacturing of the bump structures to an additive process. Thus, the method which has been lined out in connection with FIG. 2 is applied in manufacturing the front panel shown in FIGS. 3 and 4. The bump structures are generally polygon shaped; however, all bump structures comprise an apex at the top end or buildup side, and the upper boundaries provided as overhang ledges are tilted against the horizontal, i.e. include an angle with the buildup direction which is different from 90 degrees.

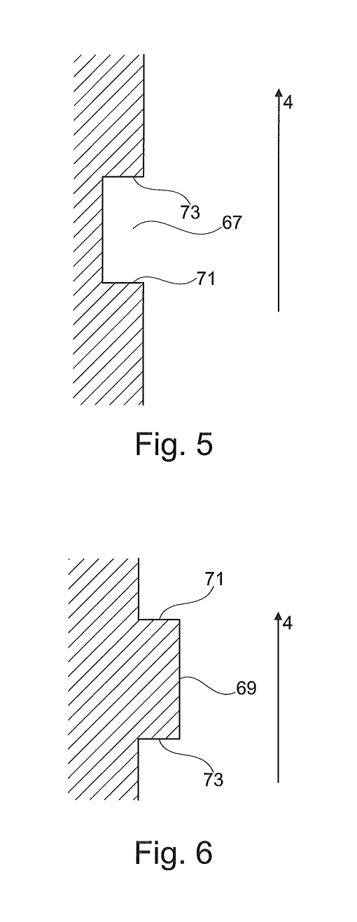

FIG. 5 shows a sectional view through a concave bump structure 67. At the top side, or in the buildup direction 4, it is delimited by an overhang ledge 73. At the bottom, or towards the base side, it is delimited by a reclining ledge 71. A convex bump structure 69 shown in FIG. 6 is delimited on its top side by a reclining ledge 71, and at its bottom side by an overhang ledge 73. Generally, it can be said that an overhang ledge comprises a ledge surface pointing towards the base of a component, while the reclining ledge comprises a ledge surface pointing into the buildup direction.

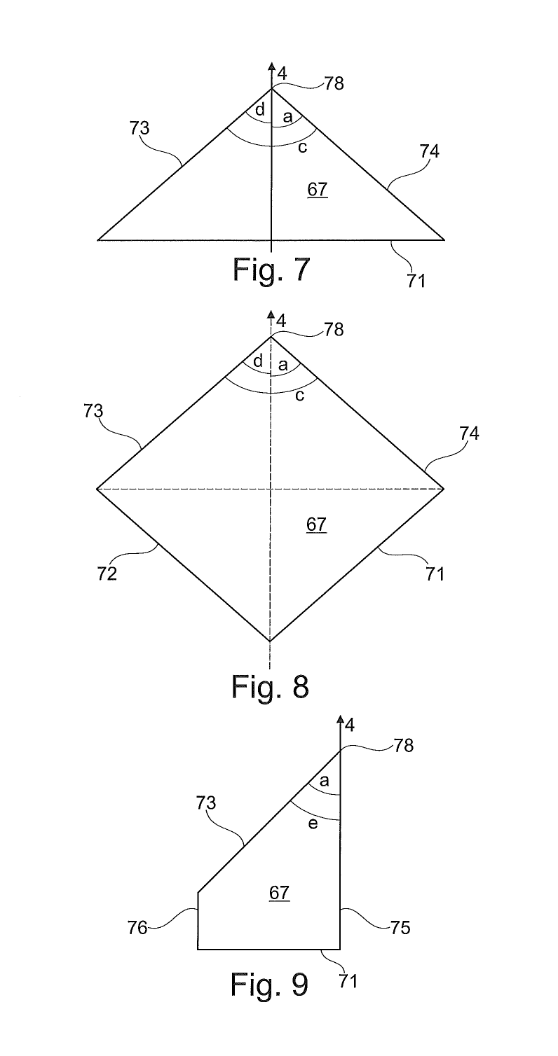

Exemplary configurations of concave bump members as may be producible by the method disclosed herein are shown in FIGS. 7 through 9. FIG. 7 depicts a first exemplary embodiment. The bump structure 67 is delimited by a delimitation comprising a reclining ledge 71 and two overhang ledges 73 and 74. Overhang ledges 73 and 74 include angles a and d with the buildup direction 4. They abut each other forming an apex 78, said apex being arranged at a buildup side of the bump structure and pointing into the buildup direction. They include an angle c with each other, which might for example be 100 degrees. It is apparent that overhang ledges 73 and 74 are well producible by the method disclosed herein and lined out in connection with FIG. 2.

FIG. 8 depicts a further embodiment of a concave bump member 67. The bump member is diamond-shaped, with the delimitation comprising two reclining ledges 71 and 72, and two overhang ledges 73 and 74. Again, the overhang ledges abut each other forming an apex 78 arranged at a buildup end of the bump structure and pointing into the buildup direction 4

Finally, FIG. 9 depicts an embodiment wherein a concave bump member 67 is delimited by a reclining ledge 71, an overhang ledge 73, and two lateral ledges 75 and 76. Again, overhang ledge 73 is tilted and includes an angle a with the buildup direction 4. Overhang ledge 73 abuts a lateral ledge 75, forming an apex 78 arranged at the buildup end of the bump structure and pointing into the buildup direction 4, and including an angle e between the overhang ledge and the lateral ledge. In this embodiment, angle e is identical with angle a, which however is not mandatory.

It will become immediately clear to the skilled person how the embodiments shown in FIGS. 7 through 9 are producible by a method as disclosed herein and lined out in connection with FIG. 2. It will also become readily apparent how the teaching given in connection with FIGS. 7 through 9 will apply to convex structures, with the apex arranged at a base end and pointing towards the base, or the bottom, respectively.

While the method and the element disclosed herein have been lined out by virtue of specific embodiments, it will be appreciated that these exemplary embodiments are not intended to limit the scope of the claims of this disclosure. It will be appreciated, that embodiments deviating from those shown are possible within the scope of the claims.

1. A method for manufacturing an element by an additive manufacturing process, the additive manufacturing process comprising consecutively adding material to the element along a buildup direction starting from a base side in producing the base side transverse to the buildup direction by the additive manufacturing process and adding material starting at the base side in consecutive steps, the method comprising manufacturing the element such as to comprise a front face extending from the base side and into the buildup direction, the method further comprising manufacturing at least one bump structure on said front face by means of the additive manufacturing process, wherein a delimitation of said bump structure comprises at least one reclining ledge and at least one overhang ledge, further comprising manufacturing all overhang ledges to form an angle with the buildup direction being smaller than or equal to 70 degrees.

2. The method according to claim 1, further comprising manufacturing at least one concave bump structure as a non-penetrating structure and manufacturing a back wall of the concave bump structure.

3. The method according to claim 1, further comprising the manufacturing at least one bump structure such that a delimitation of said bump structure comprises two adjacent overhang ledges, said overhang ledges including an angle and forming an apex, said apex being arranged at a buildup end of a concave bump structure or on a base end of a convex bump structure.

4. The method according to claim 1, further comprising manufacturing the at least one bump structure such that a delimitation of said bump structure comprises an overhang ledge and a lateral ledge, said overhang ledge and said lateral ledge including an angle and forming an apex, said apex being arranged at a buildup end of a concave bump structure or on a base end of a convex bump structure, said angle in particular being smaller than 70 degrees and in particular being smaller than or equal to 60 degrees.

5. The method according to claim 1, further comprising manufacturing at least one through opening extending from the first front face to a second front face by the additive manufacturing process.

6. The method according to claim 5, further comprising manufacturing a support structure in at least one through opening and in particular in removing the supporting structure after the additive manufacturing process has finished by a removing manufacturing process.

7. The method according to claim 1, wherein the buildup direction is bottom to top.

8. The method according to claim 1, wherein that the additive manufacturing process is selected from a selective laser melting process or a selective electron beam melting process.

9. An element producible by the method of claim 1, the element comprising a first side, a second side, and a face extending form the first side to the second side, and wherein bump structures are arranged on said face, the bump structures being delimited by a delimitation, the delimitation comprising at least one reclining ledge and one overhang ledge when the element is put down on a horizontal surface with one of the first and second sides, wherein each overhang ledge of a bump structure is tilted against a horizontal line when the element is put down on a horizontal surface with one of the first and second sides, wherein the tilt angle in particular is larger than or equal to 20 degrees.

10. The element according to claim 9, whererin each overhang ledge of each bump structure is tilted against a horizontal line when the element is put down on a horizontal surface with one of the first side and second side, and wherein the tilt angle is larger than or equal to 20 degrees.

11. An element producible by the method of claim 1, the element comprising a first side, a second side, and a face extending form the first side to the second side, and wherein bump structures are arranged on said face, the bump structures being delimited by a delimitation, the delimitation comprising at least one reclining ledge and at least one overhang ledge when the element is put down on a horizontal surface with one of the first and second sides, wherein each overhang ledge abuts a second ledge forming an apex, said apex pointing towards one of the first and second sides.

12. The element according to claim 11, wherein each overhang ledge abuts a second overhang ledge and includes an angle with the second overhead ledge, said angle being smaller than or equal to 120 degrees and larger than or equal to 95 degrees, and wherein the angle is in particular smaller than or equal to 105 degrees.

13. The element according to claim 12, wherein each overhang ledge abuts a second ledge and includes an angle with the second ledge being smaller than or equal to 80 degrees and in particular being smaller than or equal to 60 degrees.

14. The element according to claim 9, wherein the at least one bump structure is diamond shaped, wherein an angle formed between two overhang ledges is smaller than or equal to 105 degrees and larger than or equal to 95 degrees and is in particular at least approximately 100 degrees.
